(19) United States
(12) Patent Application Publication
(10) Pub. No.: US 2007/0097673 A1
(43) Pub. Date: May 3, 2007

(54) Memorial lighting systems

(76) Inventor: Robin R. Livesay, Martinsville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/262,705

(22) Filed: Oct. 31, 2005

(51) Int. Cl. F21S 8/00

(52) U.S. Cl. 362/145

(57) ABSTRACT

A method of memorializing a person or pet may include lighting a memorial lamp at a memorial service; associating the lighted memorial lamp with a memorial lamp structure at the memorial service; exchanging the lighted memorial lamp with a second memorial lamp so that the second memorial lamp is associated with the memorial lamp structure; and keeping the second memorial lamp and the associated memorial lamp structure at a memorial place. The first memorial lamp may be a flame powered lamp such as a candle. The second memorial lamp may be an electric powered lamp such as a solar powered lamp or a battery powered lamp.

### FIELD OF THE INVENTION

The present invention relates generally to memorial lighting systems.

### BACKGROUND

Candlelight is symbolically a spiritual and religious representation to many persons at the time of death in a family. The prior art does not, however, provide a system and method for the family to be an active part in the funeral service by lighting a candle on an upright memorial beside the body of the deceased and then keeping the same memorial at their home or at the cemetery. Similarly, the prior art does not provide a system and method for transitioning from traditional flame candlelight to solar flickering light.

A need therefore exists for a memorial lighting system that provides the customer with innovative options for a funeral service, for a memorial, and for adding personal meaning and memories in a difficult time. The present invention addresses these, and other, needs.

### SUMMARY

In one aspect of the present invention there is provided a method of memorializing a person or pet, said method comprising:

a) lighting a first memorial lamp at a memorial service;

b) associating said lighted memorial lamp with a memorial lamp structure at said memorial service;

c) exchanging said first, lighted memorial lamp with a second memorial lamp so that said second memorial lamp is associated with said memorial lamp structure; and

d) keeping said second memorial lamp and said associated memorial lamp structure at a memorial place.

In some aspects of the invention the first memorial lamp is a flame powered lamp, which may comprise a candle. In some aspects the second memorial lamp is an electric powered lamp, which may be a solar powered lamp or a battery powered lamp.

One application of the invention allows a family to actively participate in a funeral service and then to have a lasting tangible memorial for home, garden, or cemetery.

Another application of the invention allows a placement of a memorial light system at a gravesite or residence after a funeral, or even many years later.

The decorative memorial light system can complement a casket or can protect an urn and display if cremation is chosen.

The memorial light system may comprise an upright cylinder or square column made of wood, metal, or resin. The upright cylinder or column may be attached to a columnar cage-like structure, called a surround. A light may be attached to the top of the cylinder or square unit.

If a traditional casket is chosen, the memorial lighting system may be finished to closely match a wood or metal casket. The system may be placed at the head of the casket during the funeral service. After the service, the memorial light system may be taken to the cemetery as a memorial or can be taken home as an indoor or outdoor memorial.

If cremation is chosen, the protective columnar surround may hold the urn for services and for a home memorial. The urn may later be placed in a niche, or may be buried at a cemetery site.

The memorial light system may include interchangeable lighting which can be a wax, gel, or oil candle which may be lighted by the family and placed on the memorial light system object. At the end of the service, a solar flickering simulated candle (or steady-on if preferred) with attractive lens may be used to replace the flame candle.

The columnar surround unit can house an urn and can accept a light emitting diode that disperses light downward on the urn. The urn surround unit may have a tall cylinder or square, or may be a shelf unit with or without drawers.

If a time has passed since the death of a loved one, the memorial lighting system will likely not include a traditional flame candle but only the solar light system.

### BRIEF DESCRIPTION OF THE DRAWINGS

FIG. 1 shows one embodiment of the present invention.

FIG. 2 shows another embodiment of the present invention.

FIG. 3 shows another embodiment of the present invention.

FIG. 4 shows another embodiment of the present invention, showing a solar light affixed to a vase on a flat marker at a cemetery.

FIG. 5 shows another embodiment of the present invention.

FIG. 6 shows another embodiment of the present invention, showing a solar-powered light display and an interchangeable band saying “Beloved” with doves.

FIG. 7 shows another embodiment of the present invention, showing a solar powered light affixed directly to a surface.

FIG. 8 shows another embodiment of the present invention.

FIG. 9 shows another embodiment of the present invention.

FIG. 10 shows another embodiment of the present invention, showing aluminum and stainless steel embodiments.

FIG. 11 shows another embodiment of the present invention, showing a use as a pet memorial light, with a steady-on light, an auger, and a steel rod mounted to a 16 gauge mild steel post.

FIG. 12 shows another embodiment of the present invention, showing an apparatus with an opening on the top surface and an opening on the bottom surface to permit a post to penetrate completely through the cage-like surround.

FIG. 13 shows another embodiment of the present invention.

FIG. 14 shows another embodiment of the present invention.

FIG. 15 shows another embodiment of the present invention.

FIG. 16 shows another embodiment of the present invention.

FIG. 17 shows another embodiment of the present invention.

FIG. 18 shows another embodiment of the present invention.

FIG. 19 shows another embodiment of the present invention.

FIG. 20 shows another embodiment of the present invention.

FIG. 21 shows another embodiment of the present invention.

FIG. 22 shows another embodiment of the present invention.

FIG. 23 shows another embodiment of the present invention, showing an auger which is larger in size and may be installed in poured concrete, allowing the memorial to be placed either at ground level or high enough to allow for ground maintenance.

FIG. 24 shows another embodiment of the present invention.

FIG. 25 shows another embodiment of the present invention.

FIG. 26 shows another embodiment of the present invention.

FIG. 27 shows another embodiment of the present invention.

FIG. 28 shows another embodiment of the present invention, showing a security system comprised of stainless steel, and an adhesive system. The mount has holes drilled appropriately for accepting an electric powered lamp.

FIG. 29 shows another embodiment of the present invention, showing a mount and solar light against a mausoleum, with a vase and hook embodiment illustrated.

FIG. 30 shows another embodiment of the present invention.

FIG. 31 shows another embodiment of the present invention.

FIG. 32 shows another embodiment of the present invention. In operation, the cylinder and security unit are “loose” assembled and inserted into the vase. The nut is tightened appropriately with a socket wrench, forcing the expanding ring outward between the two inverted and opposing “V” shaped rings, contacting the inner surface the vase and securing the cylinder. The light system is then attached.

FIG. 33 shows another embodiment of the present invention.

FIG. 34 shows another embodiment of the present invention.

FIG. 35 shows another embodiment of the present invention.

FIG. 36 shows another embodiment of the present invention.

FIG. 37 shows another embodiment of the present invention.

FIG. 38 shows another embodiment of the present invention.

FIG. 39 shows another embodiment of the present invention.

FIG. 40 shows another embodiment of the present invention.

FIG. 41 shows another embodiment of the present invention.

FIG. 42 shows another embodiment of the present invention.

FIG. 43 shows another embodiment of the present invention.

FIG. 44 shows another embodiment of the present invention.

FIG. 45 shows another embodiment of the present invention.

FIG. 46 shows another embodiment of the present invention.

FIG. 47 shows another embodiment of the present invention.

FIG. 48 shows another embodiment of the present invention.

FIG. 49 shows another embodiment of the present invention.

FIG. 50 shows another embodiment of the present invention.

FIG. 51 shows another embodiment of the present invention.

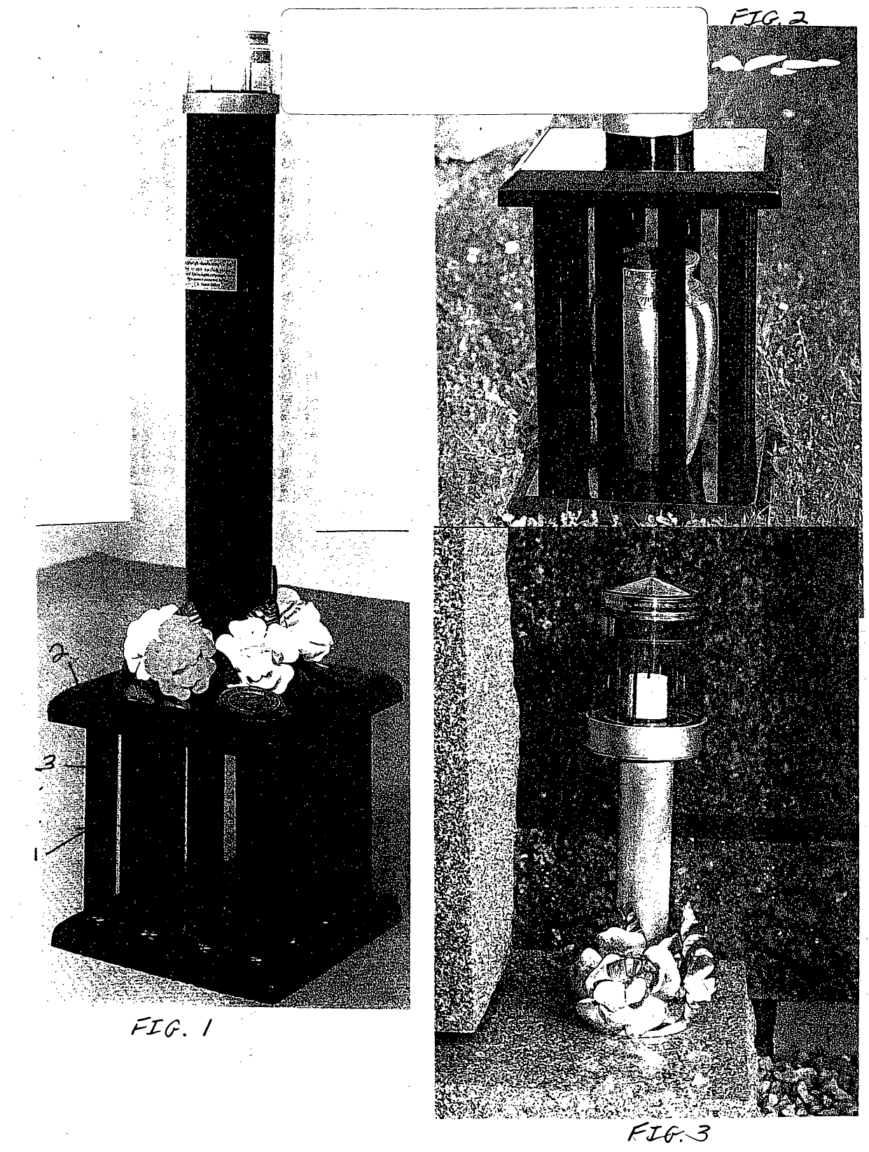

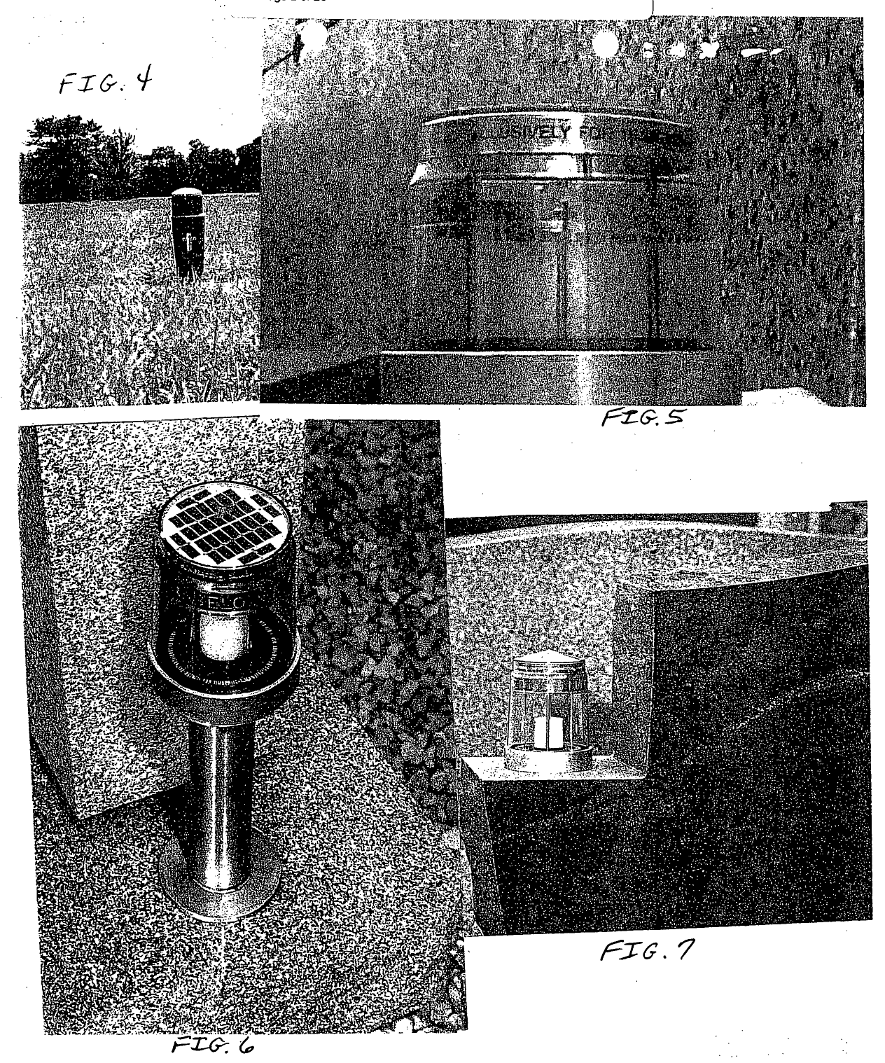

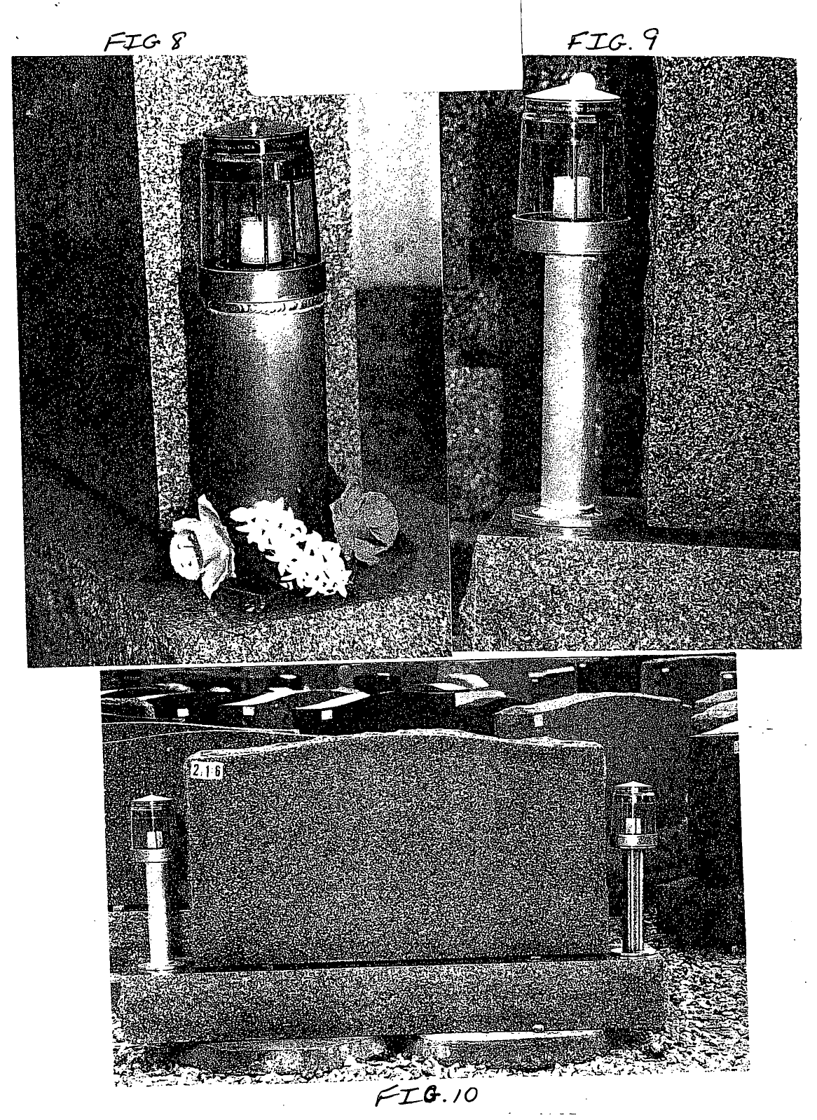

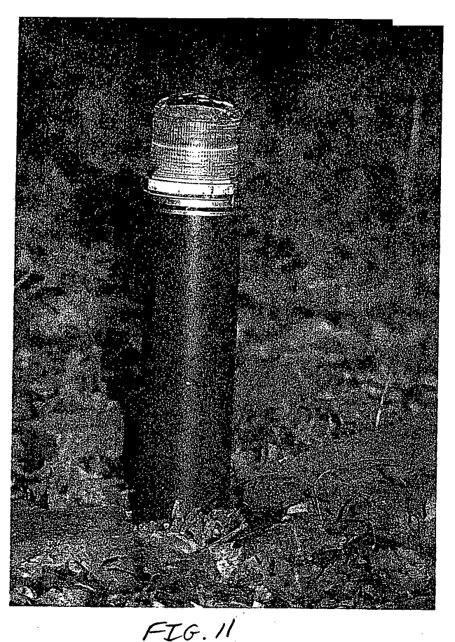

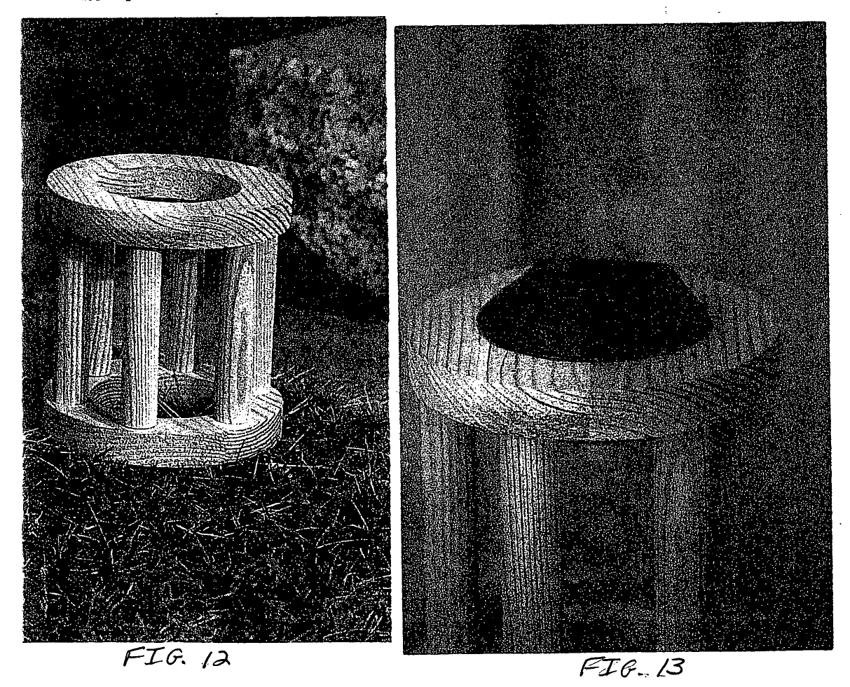

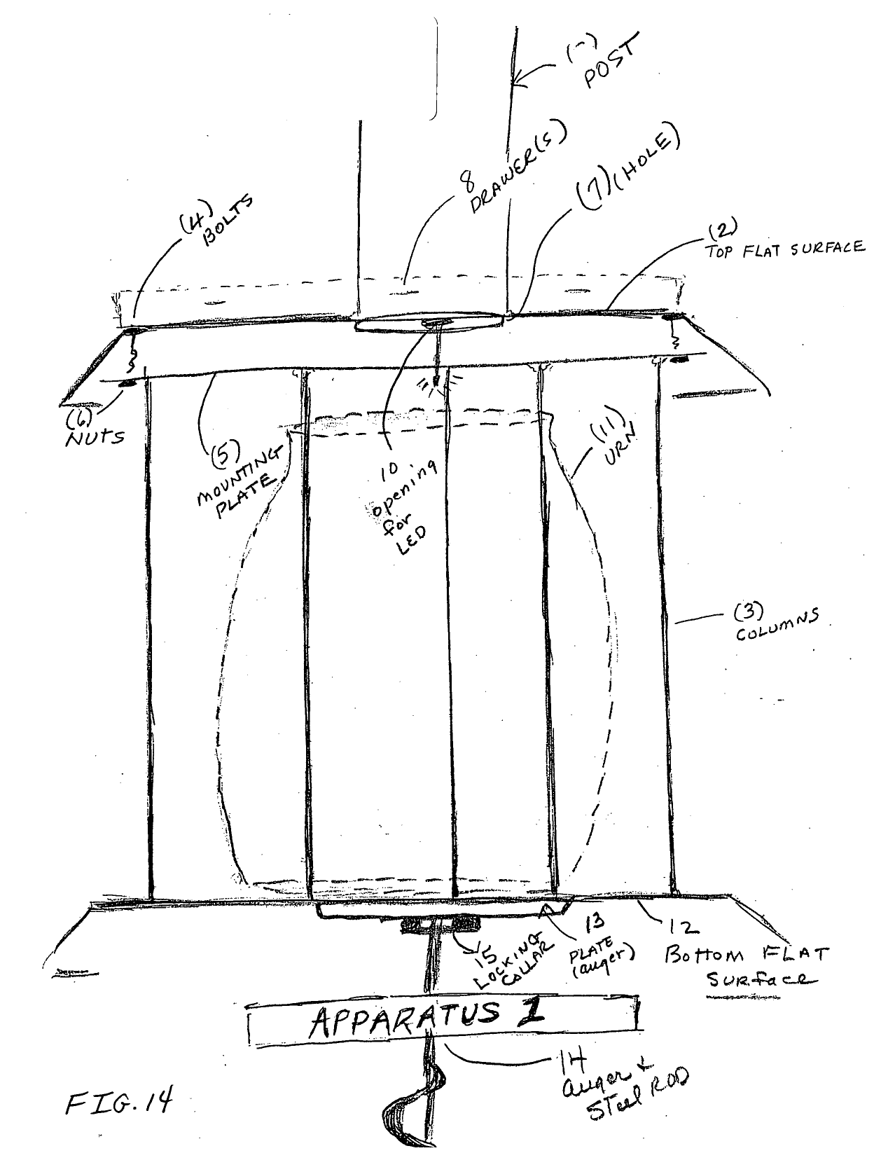

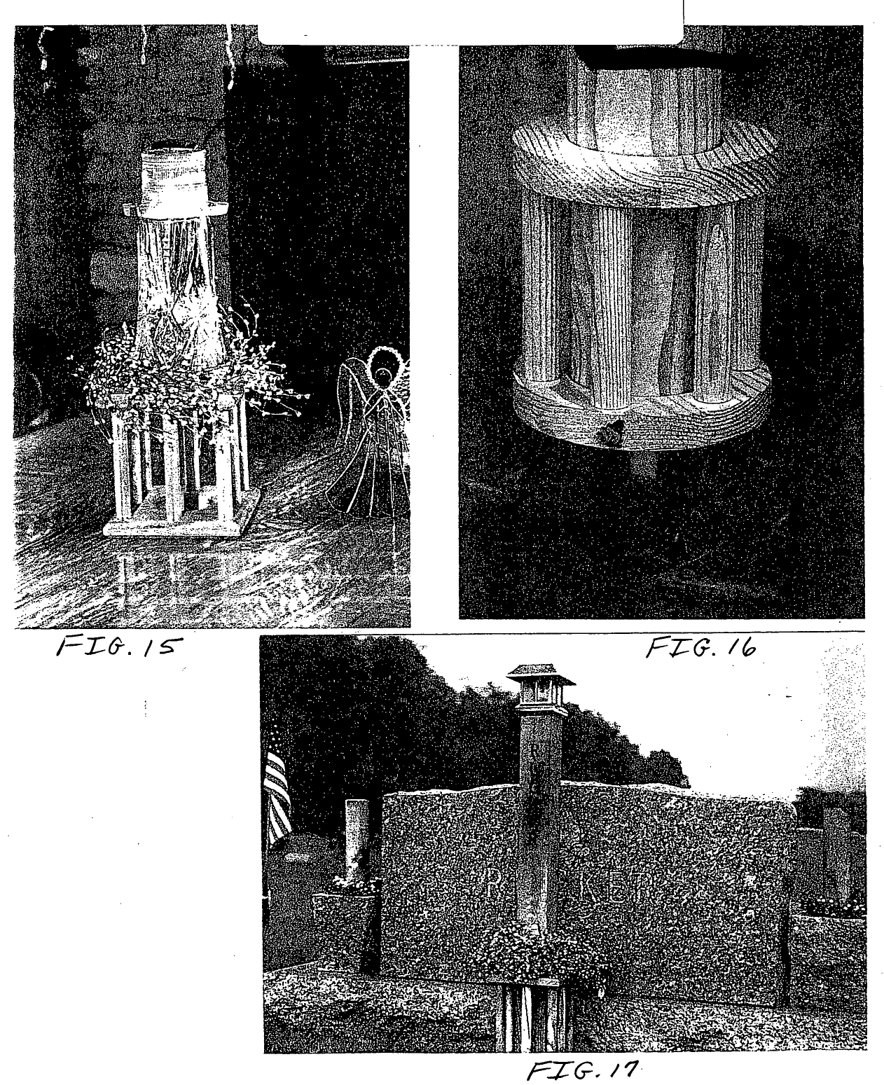

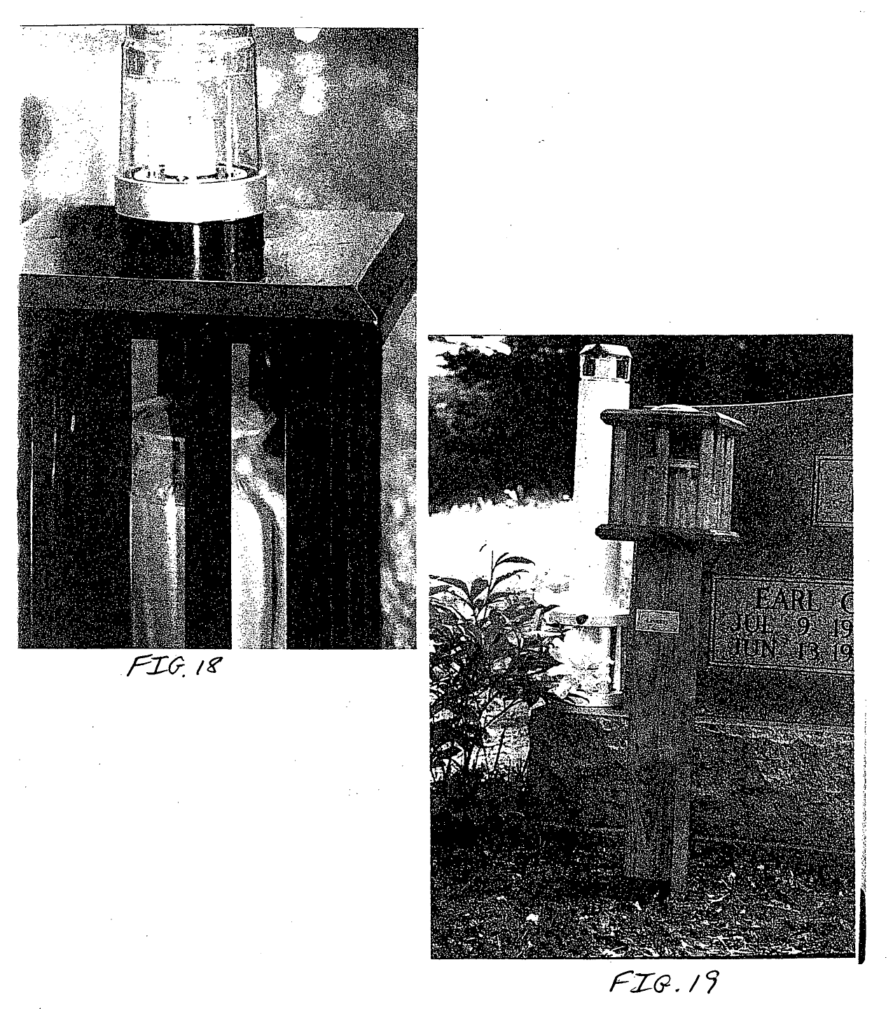

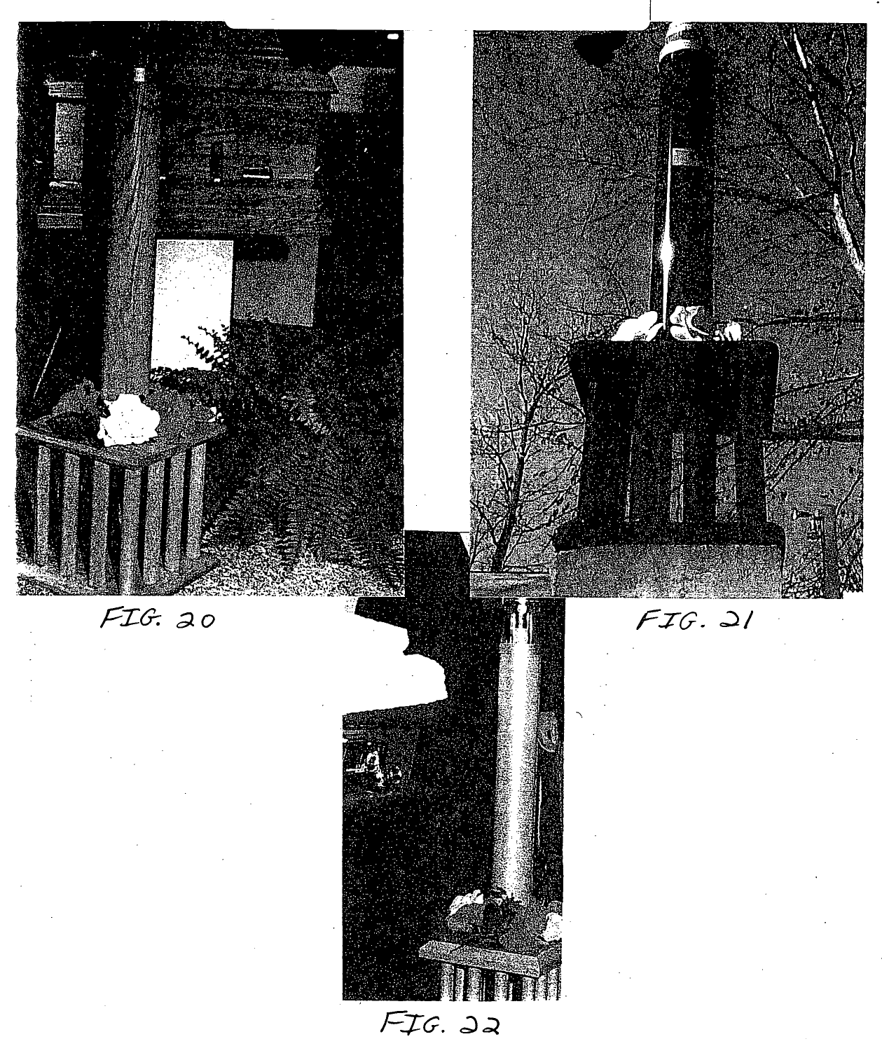

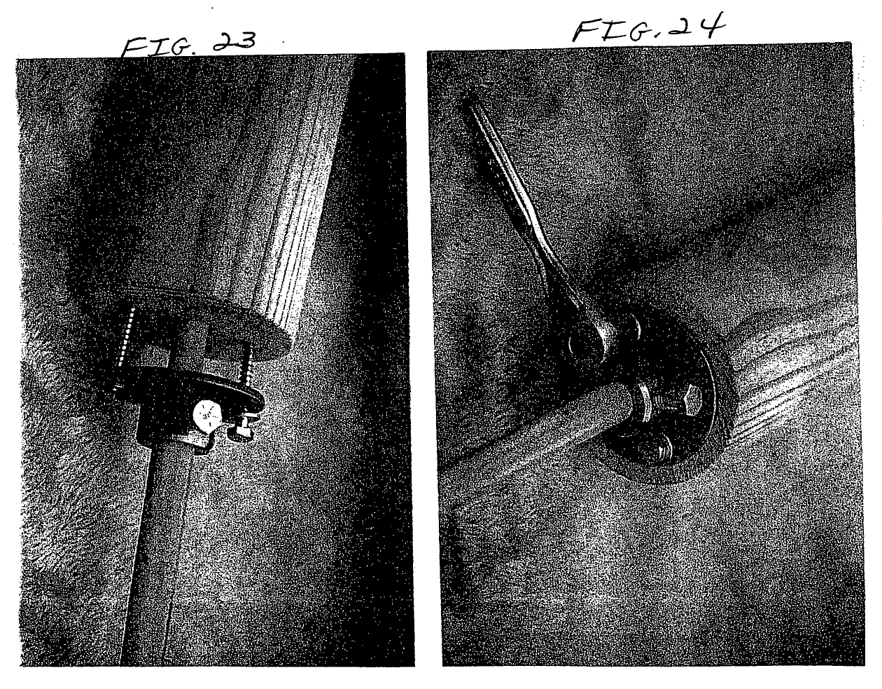

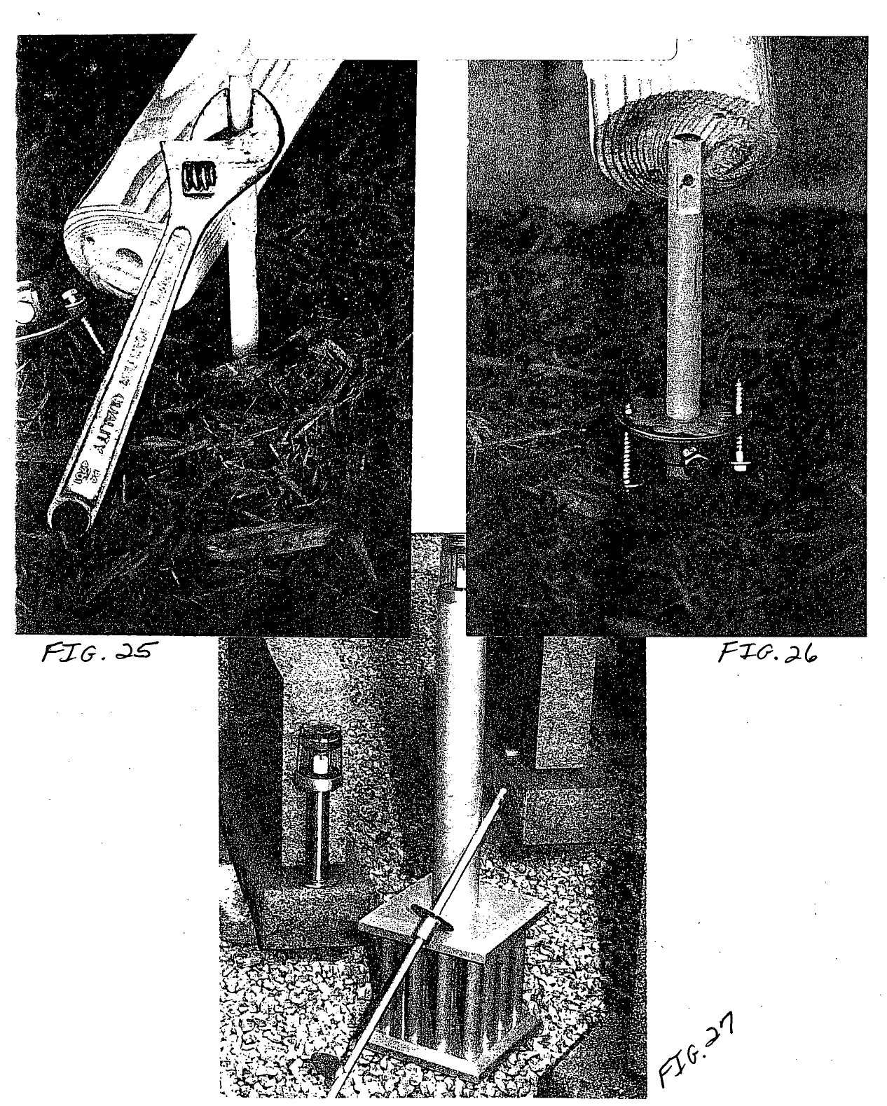

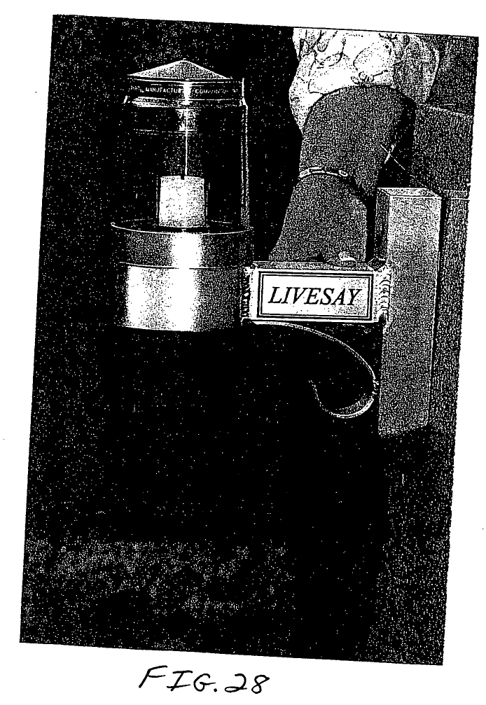

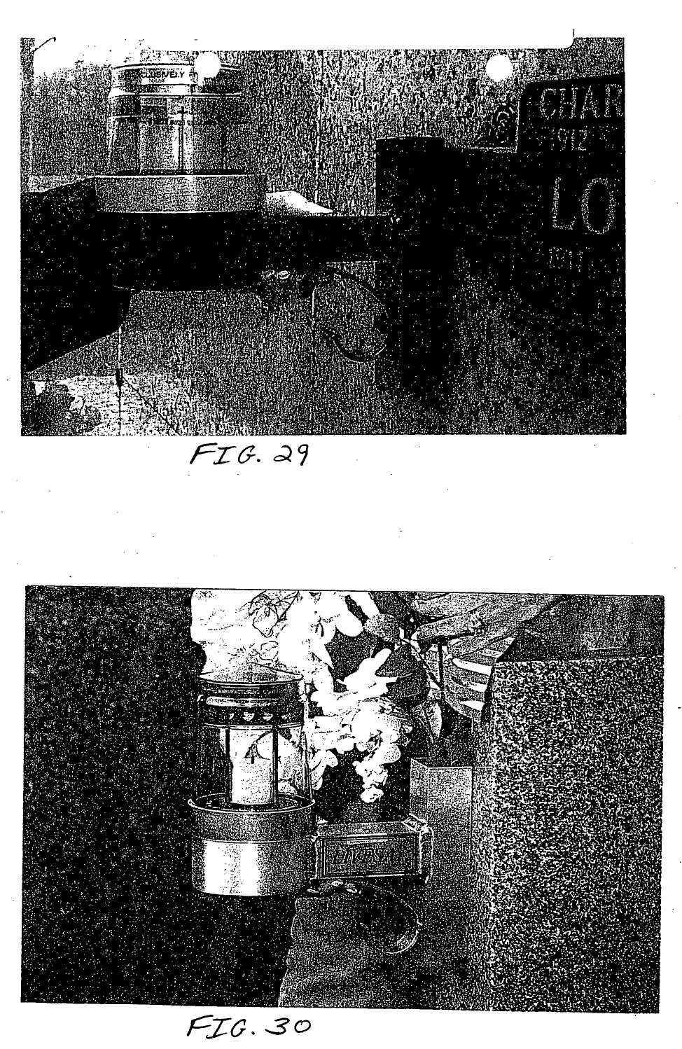

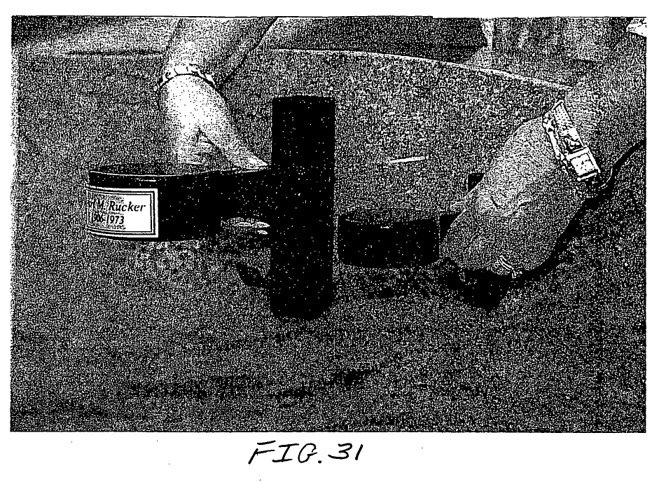

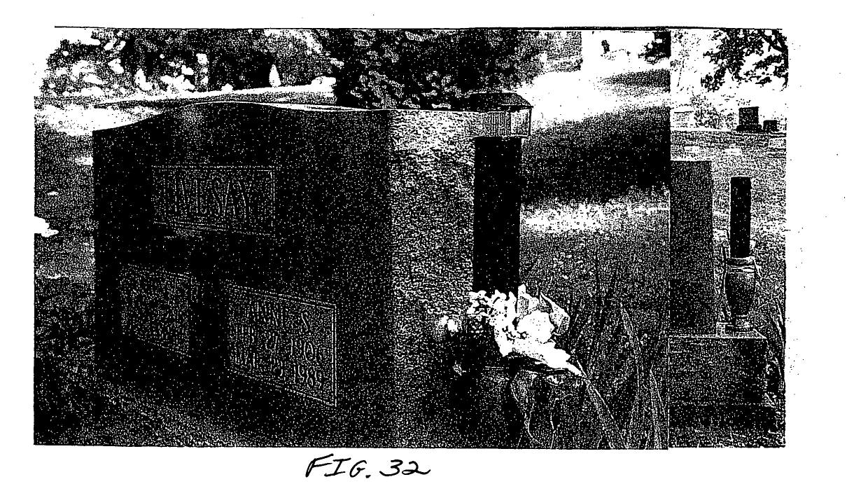

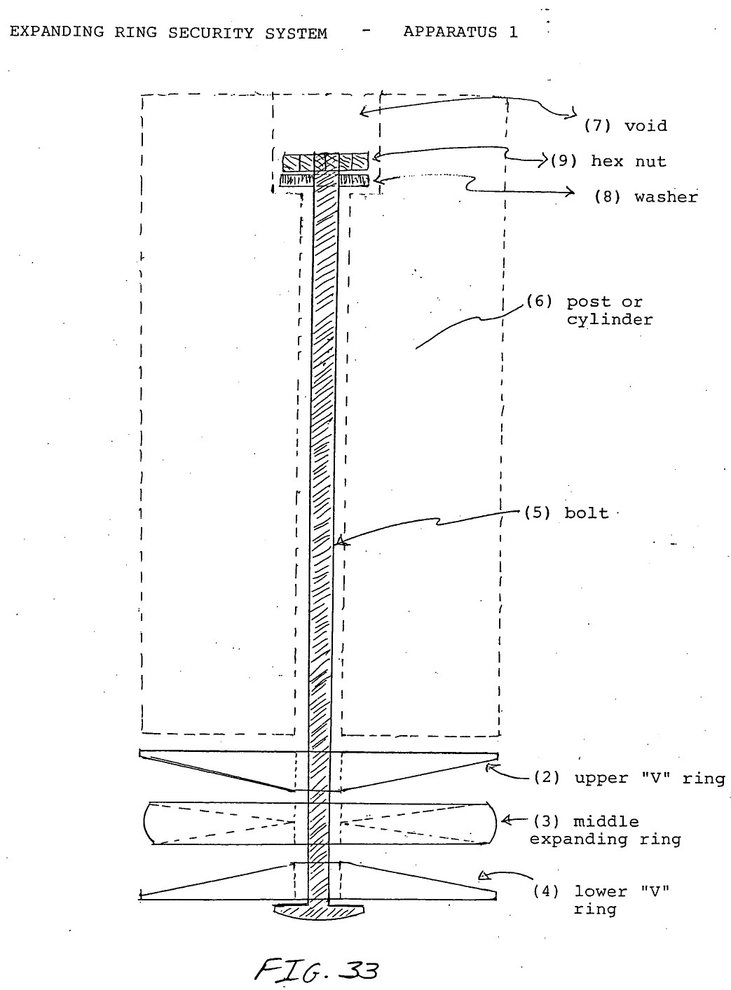

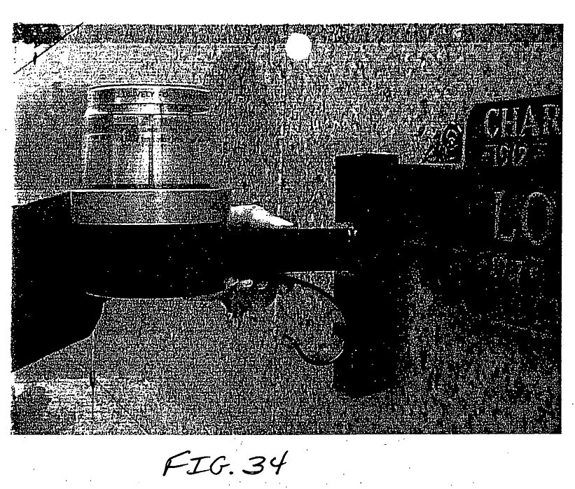

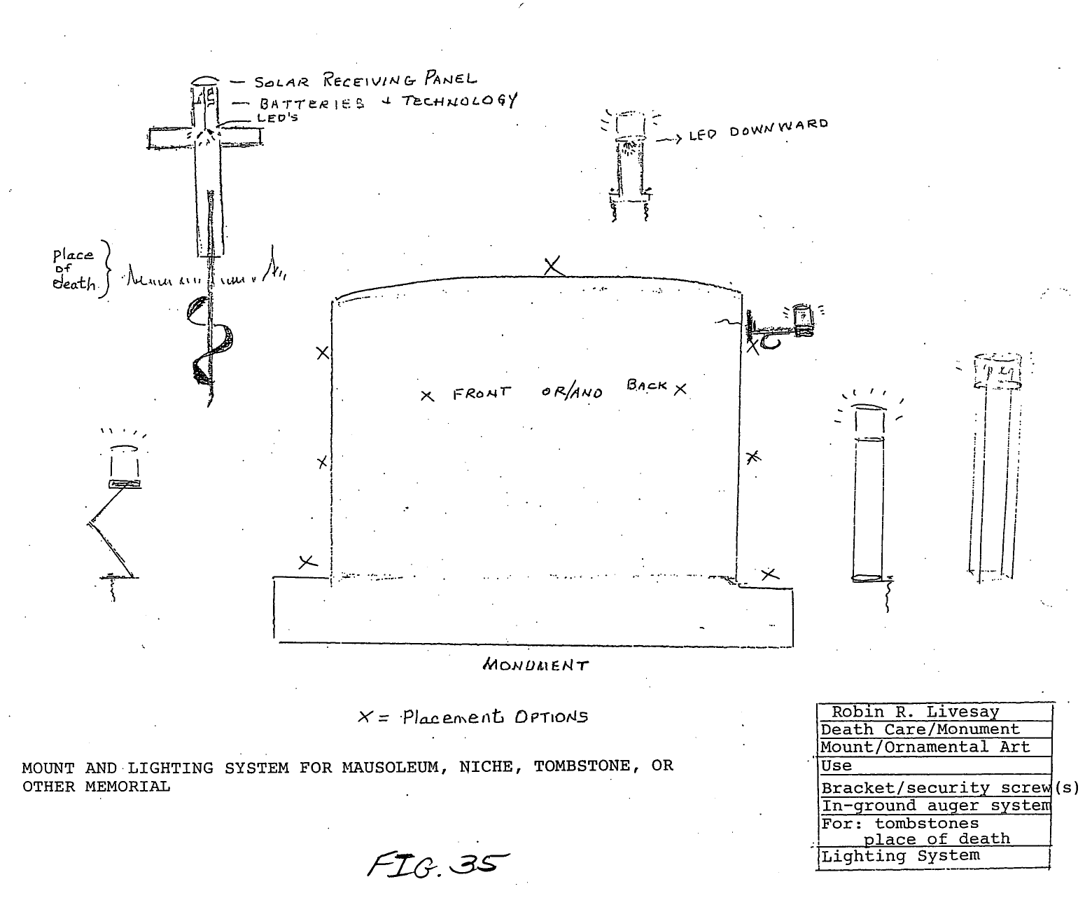

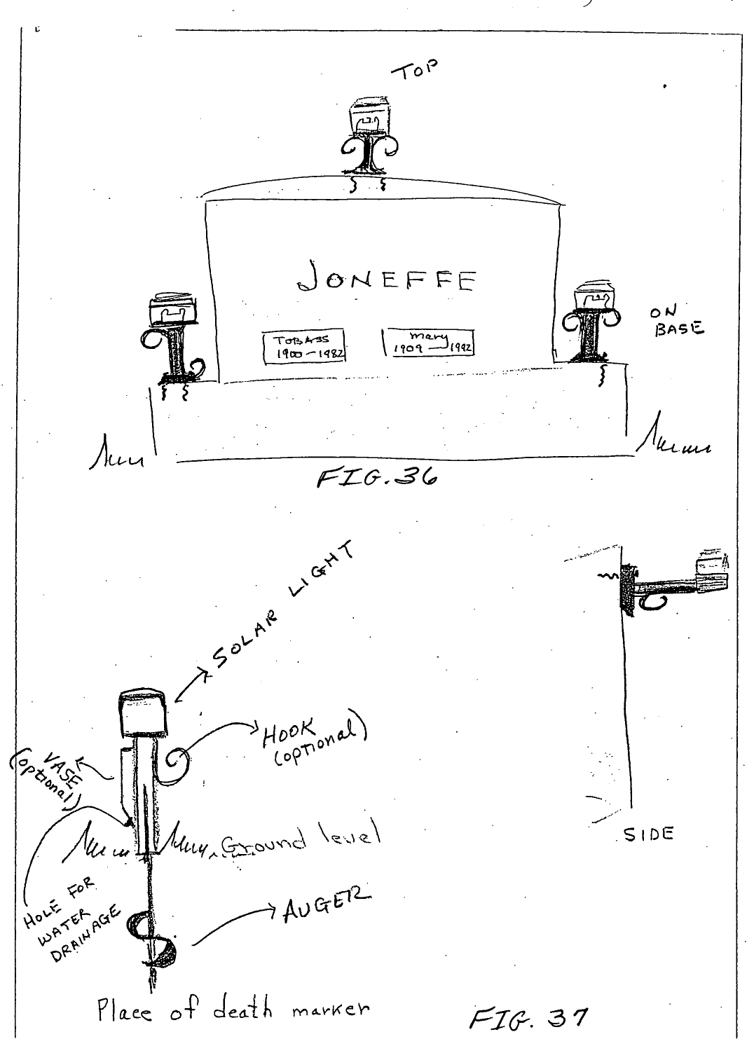

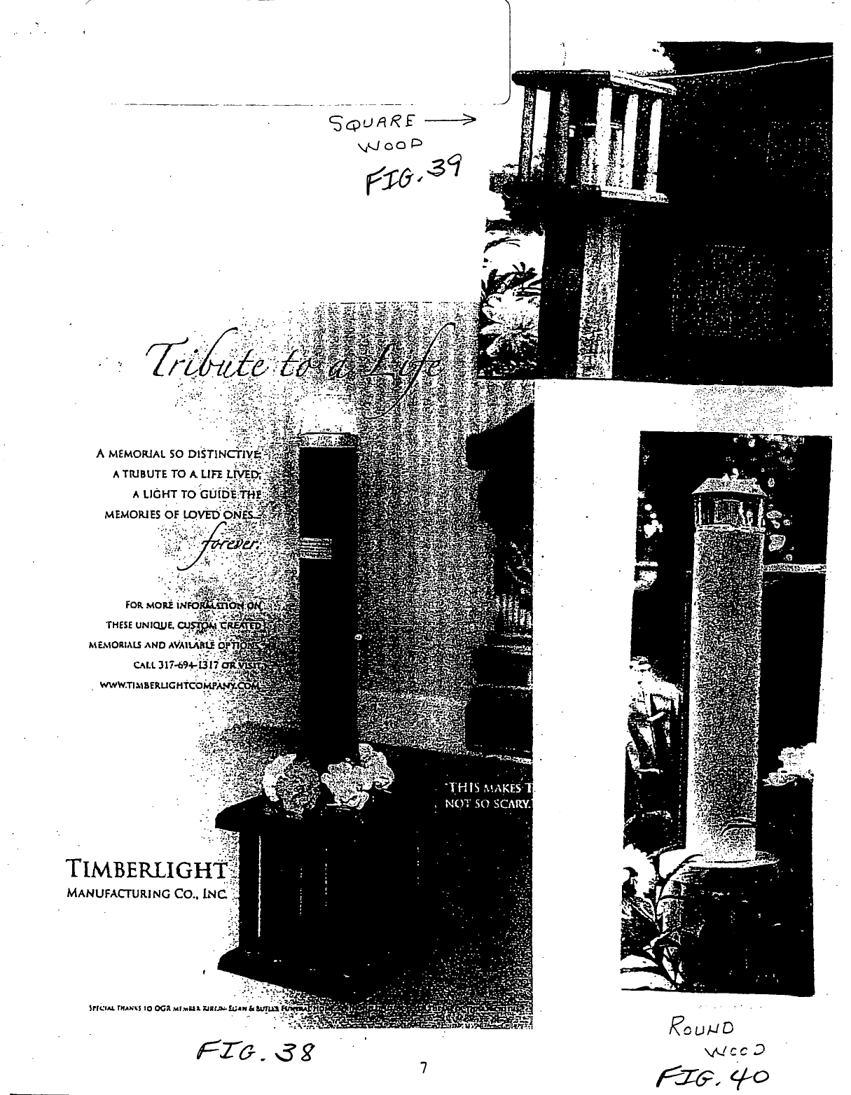

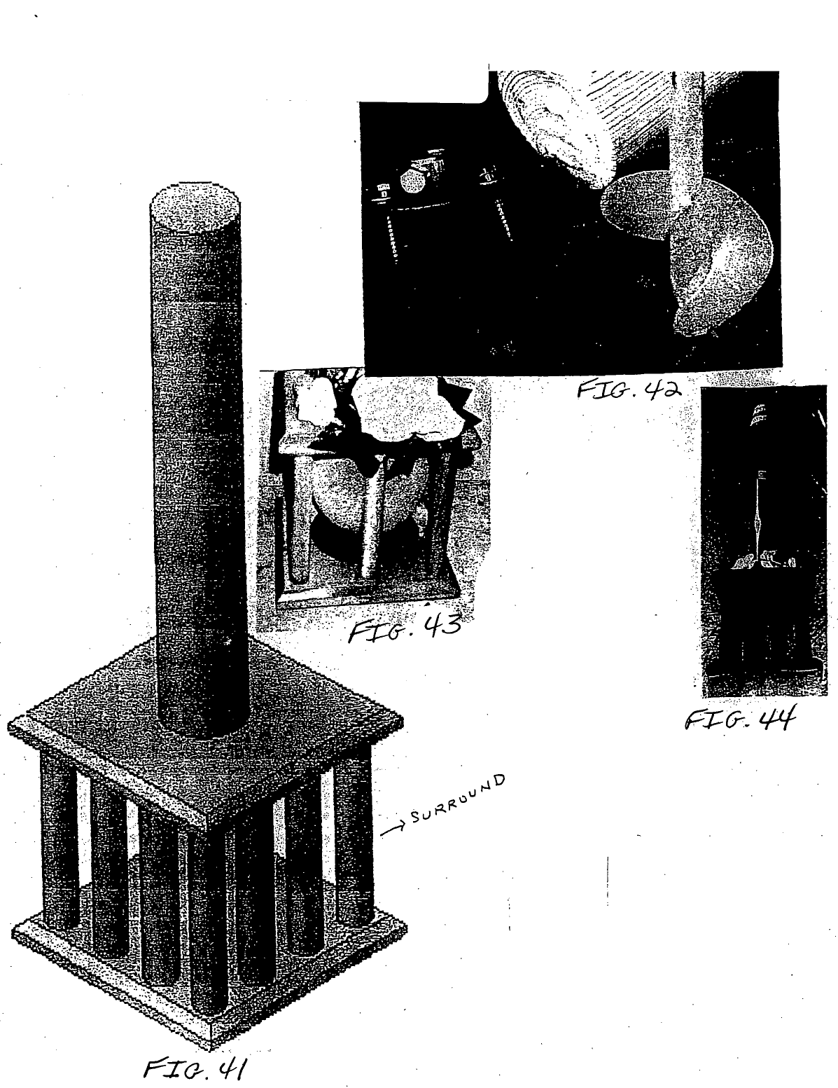

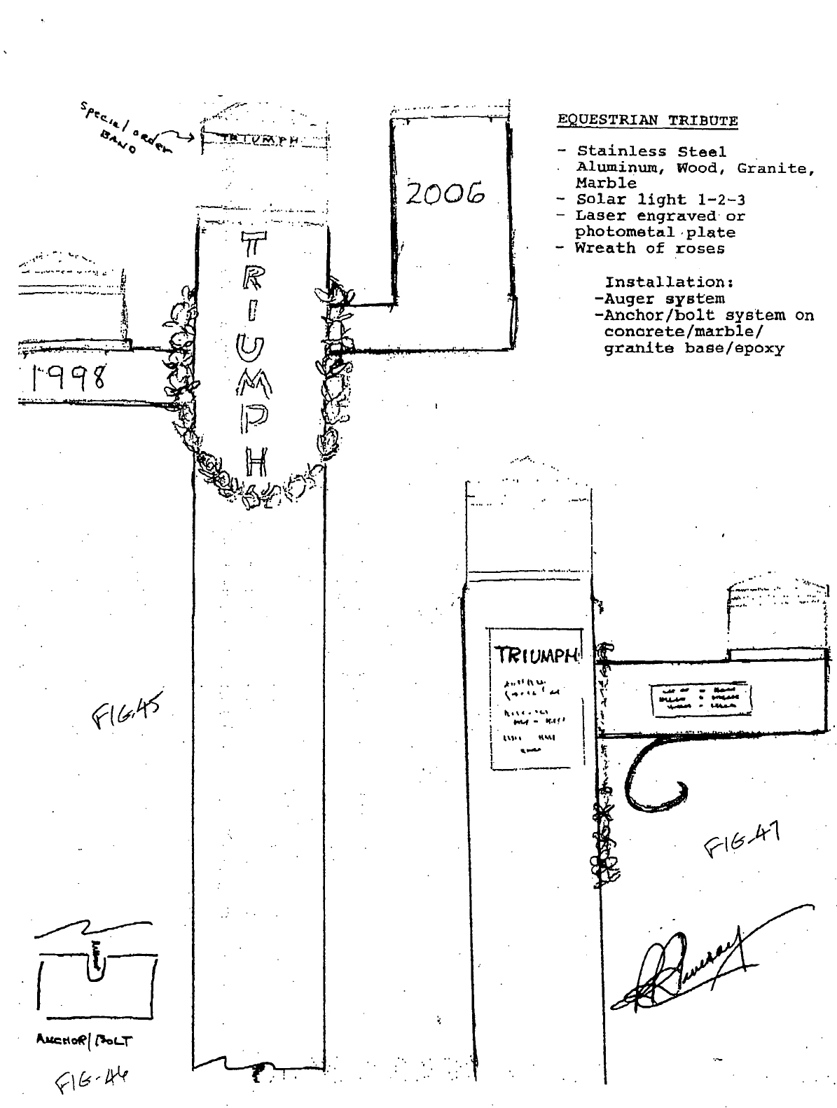

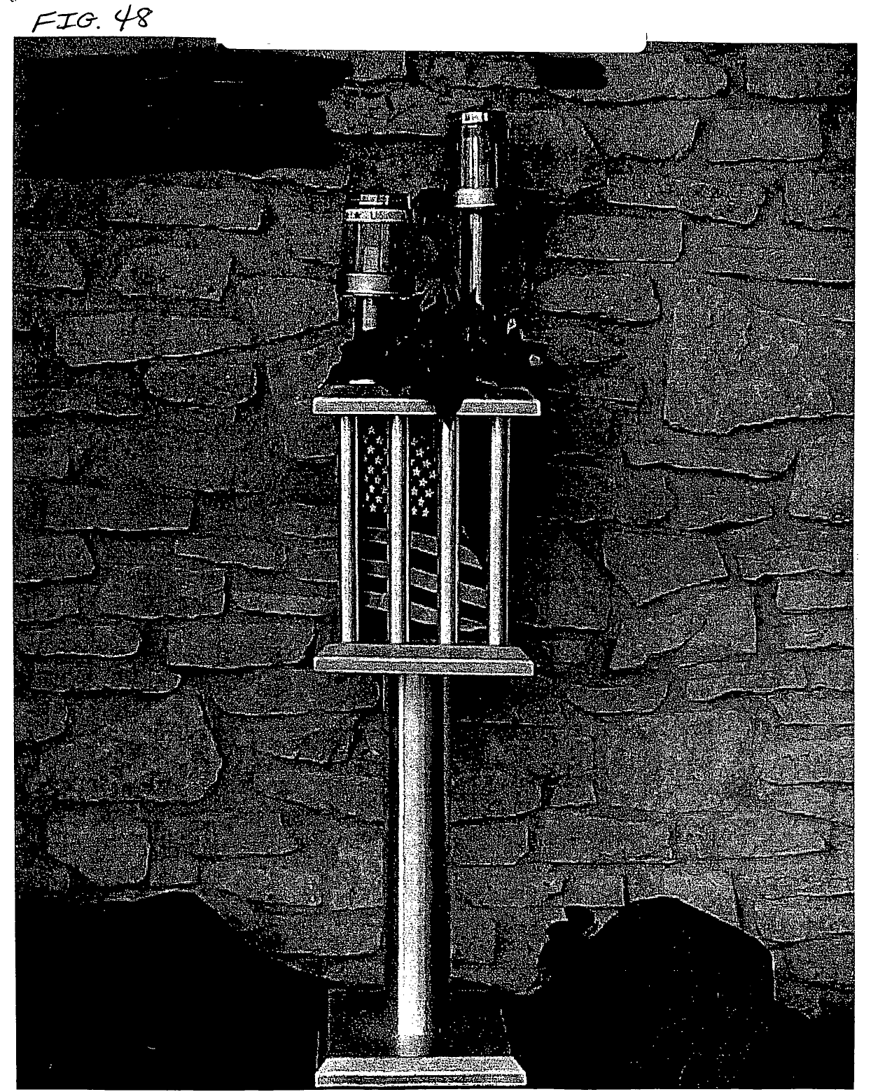

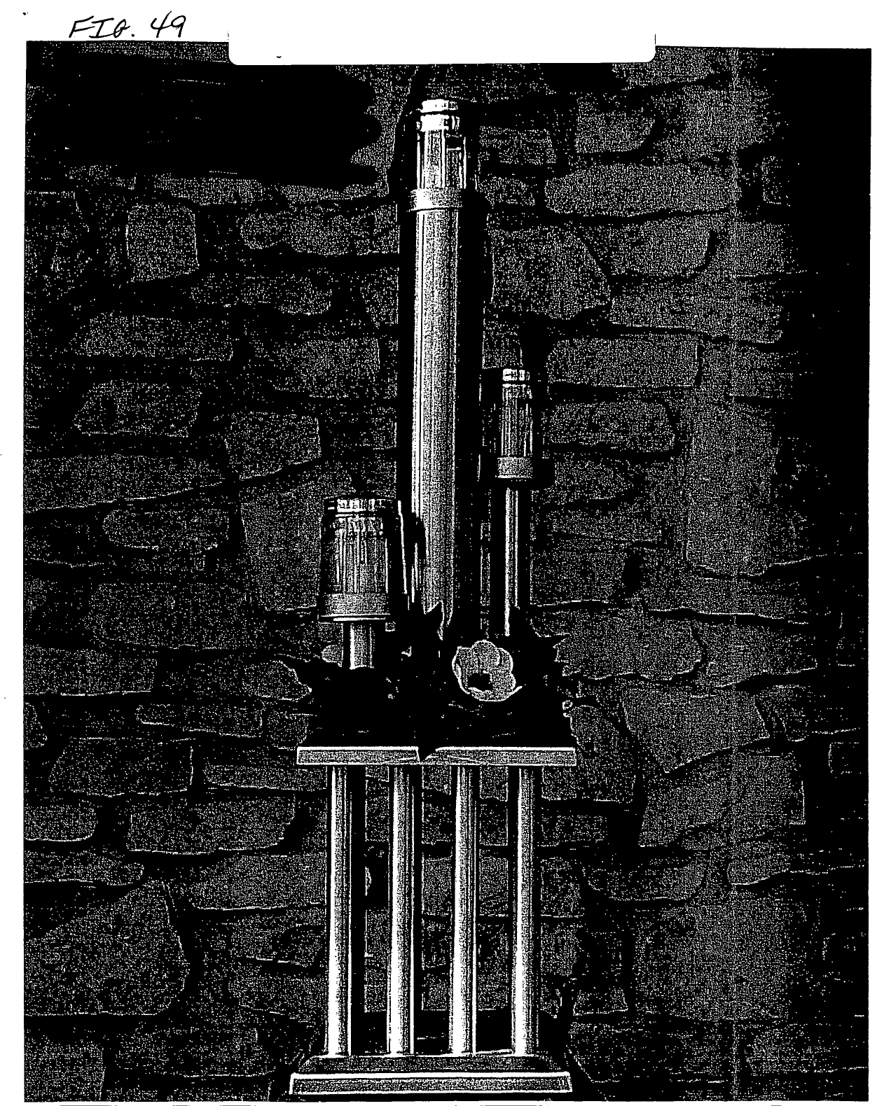

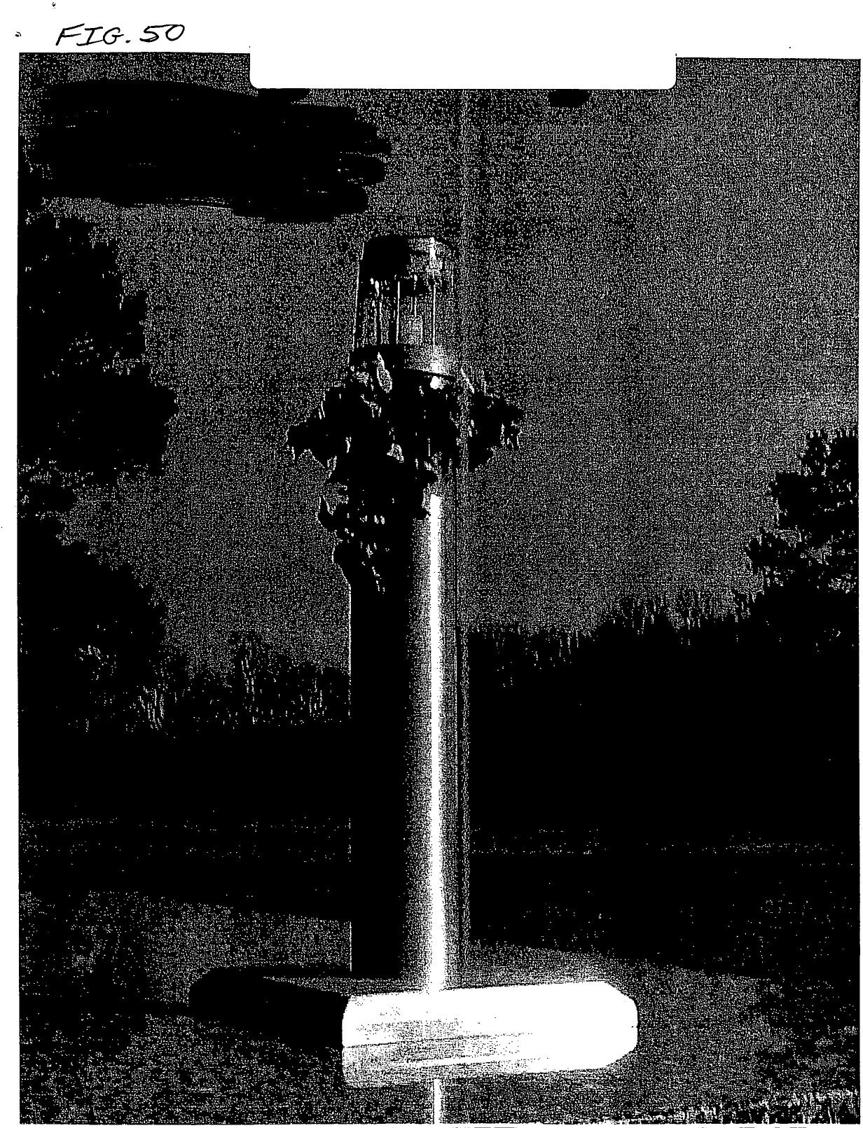

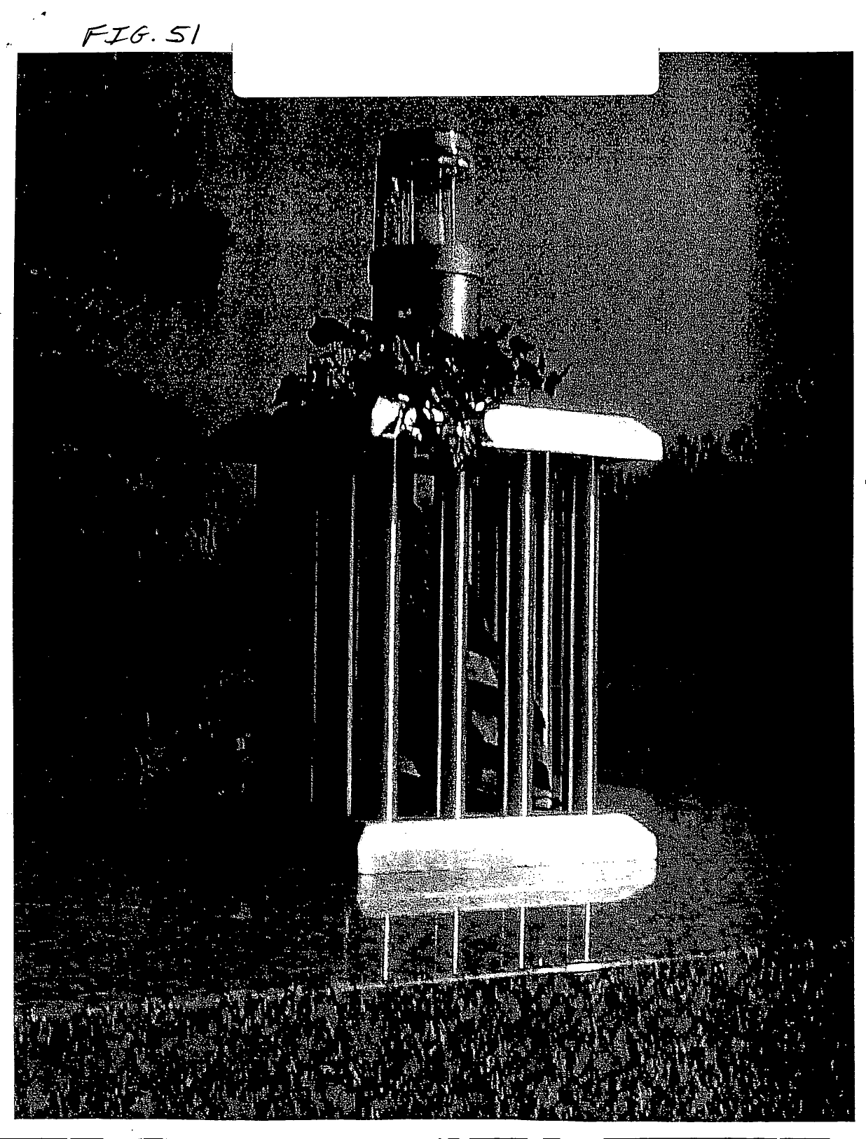

### DESCRIPTION OF THE PREFERRED EMBODIMENTS

For the purposes of promoting an understanding of the principles of the invention, reference will now be made to certain preferred embodiments and specific language will be used to describe the same. It will nevertheless be understood that no limitation of the scope of the invention is thereby intended, such alterations and further modifications in the preferred embodiments being contemplated as would normally occur to one skilled in the art to which the invention relates.

The present invention provides materials and methods for memorializing an individual, pet, or other valued being or object.

One aspect of the invention provides a memorial which utilizes a lamp element which casts a flickering candlelight, which is transportable from a funeral service to the gravesite or other memorial site, and which is appropriate for use as a cemetery or home memorial.

Another aspect of the invention provides a mount for a mausoleum, niche, or tombstone, wherein the mount holds a lamp element which casts a flickering candlelight made specifically for mausoleums and niches.

Another aspect of the invention provides a secure lighting system for existing vases that complement a tombstone or monument.

In one aspect of the invention the memorial lighting system is used during a funeral service for the family to take an active part in the funeral service by lighting a “funeral candle” upon the first visit to the funeral home and viewing the prepared body. The candle may have a real flame which is symbolic. The candle holder may be sandblasted or etched with a personal touch such as “Beloved Mother.” At the close of the funeral service, the family may extinguish the flame. The funeral director or cemeterian may remove the candle that the family has extinguished and may give that unit to the family. The self-contained and sealed solar light may be quickly and easily placed on top of the memorial. The family decides whether the funeral memorial light system is to stay at the cemetery or goes home.

Accordingly, one aspect of the present invention provides and/or utilizes a memorial lamp structure. The memorial lamp structure may have interchangeable lamp elements. In some embodiments a first lamp element is a flame-powered lamp element, and a second lamp element is an electric-powered lamp element.

In one aspect of the present invention the person(s) utilizing the memorial lamp structure lights a first lamp element to provide flame light during a memorial or funeral service. Either the person(s) utilizing the memorial lamp structure or some other person(s) may than change from the first lamp element to a second lamp element during or after the close of the service. The second lamp structure may then be placed at a graveside or memorial site.

The first lamp element may be a flame-powered lamp element such as a wax or gel candle or an oil lamp. The first lamp element may use a specialized holder.

The second lamp element may be an electric-powered lamp element, such as a lamp element that is powered by solar, battery, or other electric source. The second lamp element may be comprised of one or more LEDs which may disperse light which resembles a flickering candle and/or may cast light downward.

The second lamp element may utilize an interchangeable decorative band placed inside the lens that may personalize the lamp and lets light shine through the image on the band.

The second lamp element may be powered by solar energy and/or may use batteries, which may be rechargeable. When the second lamp element is to be placed indoors, such as in a mausoleum, batteries are preferred.

The second lamp element may be flickering, or may be steady on.

In some preferred embodiments the second lamp element may use a solar receiving panel such as a 2″ to 6″ diameter solar receiving panel. The solar receiving panel may use a horizontal or a vertical array design.

The second electric powered lamp element may be used alone as an individual lamp such as a flickering table candlelight, or may attach to a post, a sconce, or to or as a part of other decorative arrangements.

The second lamp element may utilize LEDs of different color and intensity.

The second lamp element may utilize an interlocking security band at its base for providing security and stability to the lamp unit.

The second lamp element may be secured to a stub, post, or stone utilizing appropriate stainless steel, masonry, or other screws.

In some embodiments the memorial lighting system provides or utilizes a post system. The post system may be a cylinder- or rectangular-shaped post system, or may be another shape or design. The post system may act as part of the memorial, and may provide:

1) a mount for a lighting system; and/or

2) an attachment to a decorative cage-like surround; and/or

3) a memorial to be attached to an auger and steel rod.

The post system may be comprised of steel, aluminum, bronze, marble, granite, plastic (such as acrylic), or wood.

A post system may be comprised of single or multiple posts. Each post may have a cross-section of which preferably ranges from 2″ to 8″. Acrylic posts may be flared and/or have a design to disperse different patterns of light.

Each post may range in length from ¼″ (a stub to accept said lamp element) to 48″ or more.

Wall thickness of fabricated metal posts is determined by material used.

Wood or other materials used for a post may have an insertion stub on one end to fit in a vase traditionally found complementing cemetery monuments or tombstones.

Wood or other materials used for a post may have one end designed for an insertion stub that attaches to an expansion unit.

A top plate may fit exactly the shape and size of the post(s). Some top and bottom plates will extend beyond the post(s). Top plates may be drilled to accept a lamp element. Top plates may be drilled to fit on a powder coating or other finishing machinery.

Top plates may be made of wood, metal, plastic, or other material.

Bottom plates may fit exactly the shape and size of the post(s), or may extend beyond the post (as a flange). Bottom plates may be drilled to accept an auger and steel rod. Bottom plates may be drilled to accept screws or other mounting means for placement on monuments or other surfaces.

Bottom plates may be made of wood, plastic, metal, or other material.

A taller post may be deeply bored to accept a security and stabilizing auger, steel rod, and locking collar system for ground installation.

The post may be appropriately drilled to accept a nameplate and/or other decorative attachments (flowers, medallion, etc.)

The post may be powder coated or stained and preservative finishes applied.

In some embodiments the memorial lighting system provides or utilizes a surround for a memorial light, urn or other keepsake. The surround may provide a cage-like structure which:

a) may house an urn which holds the remains of a cremated human being or cremated pet;

b) may provide protection for the urn;

c) may provide an embodiment that can accept an upward protruding object which may affixed to its upper surface;

d) may provide an embodiment that may accept a downward protruding object which may be affixed to its lower surface;

e) may provide an enclosure for an urn containing human remains, pet remains or momentos;

f) may provide a movable holder for an urn holding human remains or pet remains; and

g) may provide an embodiment holding an urn that is appropriate for home display.

The memorial surround may be in the shape of a square or circle or other shape that resembles a cage.

Referring now to the drawings, and particularly FIG. 14, surround apparatus 1 may be include a top flat surface 2 which may be beveled on some or all edges.

Welded embodiments or other methods of attachment on the underneath of the top flat surface 2 of apparatus 1 may be four or more columns 3 of various shapes with ¾″ to 2″ outside dimensions which protrude downward 4″ to 18″.

A top flat surface 2 of surround 1 may have bolts 4 welded to the underneath for accepting a mounting plate to permit removal in order to place an urn, mementos, or a lamp element inside the surround.

A mounting plate 5 may be welded to the top of one or more of the columns. The top surface 2 fits on top of the mounting plate and nuts are tightened.

A top square or other shape flat surface embodiment of surround 1 may have a hole in the top to accept a solar panel or an indentation to accept a decorative object or memento.

A top square or other shape may serve as the base or bottom of a drawer 8 or drawers for mementos. The drawer or drawers would be proportional in size to the rest of the apparatus.

A top flat surface 2 of apparatus 1 may accept on the top a post of ½″ to 40″ (9). In this case, a drawer 8 would likely become two or three small drawers where the middle may house a post.

A top square or other shape flat surface 2 of apparatus 1 may have a drilled hole in the center for accepting a wire and LED 10 which will provide lighting on an enclosed urn 11.

An embodiment consisting of a 12″×12″ square or other shapes or other dimensions consisting of a bottom flat surface 12 of apparatus 1 may be beveled on all edges.

Welded or pressed embodiments on the top of the bottom flat surface 12 of apparatus 1 provides the base for four or more columns 3 of various shapes which may measure ¾ to 2″ outside measurement and protrudes upward.

Welded or pressed protrusions may be on the underneath of the bottom flat surface 12 of apparatus 1 for accepting a plate 13 which may support an auger and steel rod 14 arid provide protection for the apparatus 1 from weather.

The embodiment 11, the bottom flat surface, may accept a post 9 of 10″ to 40″ underneath which puts the cage on the top of the post rather than at the bottom as previously described.

The top flat surface 2, with only ½″ post protruding from the top accepts a solar lamp as previously disclosed.

The embodiment when accepting the auger and steel rod 14 may have a welded or other method of attaching a steel or aluminum or stainless steel locking collar 15 to the attached plate 12 which supports the collar and the auger and steel rod.

The apparatus 1 may have an opening on the top surface and an opening on the bottom surface to permit a post 9 total entrance through the top plate or surface 2, through the cavity of the apparatus 1, and through the bottom plate 12, thus allowing a post to penetrate completely through the cage-like surround.

The apparatus 1 as previously described may be made of 16 gauge mild steel, aluminum, stainless steel, bronze, marble, granite, or wood and may include an attached post.

The apparatus may be used as a part of a funeral service for memorializing a deceased person and may closely match a casket color and may involve the family in the funeral service. The apparatus may be used as a memorial to be taken from the funeral home after a funeral service to the cemetery. The apparatus may be a memorial to be used at a residence or at a cemetery or burial site. The drawer(s) is/are optional. The apparatus may utilize metal flowers or silk flowers. The apparatus may be used to memorialize a deceased or cremated pet, including large animals such as horses, etc., and may even be used to memorialize other living things or inanimate objects.

The present invention may also provide a secure system for mounting for a memorial lighting system. Prior art designs have attempted to solve the problem of providing a secure memorial candle mounting; i.e, one which is not subject to removal. Such systems have proven to be overly complex and costly to manufacture and have thus not found widespread use in the art. Prior art systems in use further do not effectively prevent removal or tampering.

Accordingly it is an object of the present invention to set forth a novel memorial candle support with greatly improved security features.

It is also an object of the invention to demonstrate a memorial support system which is easily installed.

The auger system may be utilized in different sizes to accommodate the weight, height, and stress of the memorial lighting system.

The auger and steel rod may attach to the plate which may be affixed to the bottom of the cage-like surround.

The invention may utilize a previous patented auger and/or may introduce a locking collar and security screw which may be attached to the plate or may slip over and around the steel rod of the auger.

The auger may be smaller in size and may be hand installed in the ground with a common tool.

The auger may be larger in size and may utilize poured concrete installation or a machine or several persons to rotate the auger into its place.

The auger and steel rod allows the memorial to be placed at a memorial site either at ground level or high enough for ground maintenance.

The invention may also provide a secure mounting and electric-powered lamp to be used on mausoleums or niches.

Prior art designs have consisted mainly of plastic vases to hold flowers or wreaths or other objects that have tended to have a short life span, either because of deterioration, theft, weather, or vandalism.

The present invention may provide a useful, long-lasting mount and lighting system as a memorial to a deceased person. The mount and lighting system may be comprised of a mount made of aluminum, stainless steel, bronze, wood or other material. The mount may be different designs and different colors. The mount may have a vase for flowers and a hook for hanging mementos. The mount may be different sizes—smaller ones for niches and larger ones for mausoleums. The mount may be made of wood designed for, but not limited to, indoor mausoleum or niches. The mount may have a holder for a lighting system which may be battery powered or solar powered. The mount may have a nameplate. The mount may have metal flowers. The mount may have silk flowers for indoor use. The mount may attach to a mausoleum, a niche, a granite monument, a marble monument, other tombstones or structures such as an entombment building or other buildings, posts, or structures outside the death-care industry. The mount may attach to side, top, front, and/or back of a granite or marble or other structure. The mount may be comprised of metal, wood, plastic, or another material. The mount may be decorative and preferably ranges in length from 5″ to 24″.

A steel, metal, wood, plastic, or bronze decorative mount with a weather and rust resistant back plate which may be the back of a vase.

Families of loved ones often purchase “flower” vases to accentuate memorials at a cemetery. Vases are usually made of aluminum, granite, marble, or bronze. These vases are typically placed on each side of a monument or in some cases, a center vase is chosen. In the case of flat markers, a bronze vase is usually brought above ground by use of a bayonet fixture or other similar fasteners. Those skilled in the art will know that vases at cemeteries are often empty. Plastic, silk or live flowers are often wilted, faded, blown away, or stolen. There are few other options for vase inserts. One aspect of the present invention provides a different and novel option that provides a soft flickering light system, is long lasting, and secure.

It is an object of this invention to offer a wood, steely, or plastic or acrylic post, cylinder or other shape designed to fit into existing or new memorial vases and to attach a lighting system previously disclosed, and a security system.

The security of vases and cemetery decoration is an important issue of this invention. An innovative expanding ring system attached to the unit and inserted into existing vases provides a new level of security not heretofore known or available to those persons decorating resting places of the deceased.

This vase insertion may comprise:

1) A previous disclosed electric-powered lamp element which may be an appropriate size relative to the vase;

2) A previous disclosed post or cylinder or other shape, made of steel or wood or other material that has a design and size that will allow insertion into the vase. The internal dimensions of vases vary thus the insertion end of the post or cylinder or other shape will adopt different bottom shapes to fit into the receptacle;

3) The electric-powered lamp element is attached to the upper end of the post, cylinder, or other shape.

4) The expanding ring security system is attached to the lower end of the post or cylinder or other shape.

The expanding ring security system (apparatus 1) is comprised of:

a) A thick metal or plastic ring having a flat upper surface, but having its lower surface “V” shaped (2);

b) A thick middle ring of a “sticky” rubber-like expanding compound (3);

c) A thick metal or plastic ring having a flat lower surface, but having its upper surface “V” shaped (4).

d) A long bolt (5) (similar to a carriage bolt) is attached to the lower ring (4) and extends upward through that lower ring, through the expanding middle ring (3), through the upper ring (2), and nearly through a bored opening in a cylinder or square or other shape, ending in a void (7) drilled into the cylinder or other shape near the top. The bolt terminates with a washer (8) and hex nut (9) within the void.

In operation, the cylinder and security unit is “loose” assembled, arid inserted into the vase. The nut is tightened appropriately with an ordinary deep socket wrench. This action forces or “squeezes” the expanding ring outward between the two inverted and opposing “V” shaped rings, contacting the inner surface of the vase with quite some force and thus securing the cylinder. The light system is then attached, completing the installation.

One preferred security system includes the combination of an anchor/bolt, epoxy, and VHB tape.

It will be apparent to those skilled in the art that many changes and substitutions can be made to the apparatus and preferred embodiment herein described without departing from the spirit and the scope of the present invention as defined.

1. A method of memorializing a person or pet, said method comprising:
a) lighting a first memorial lamp at a memorial service;
b) associating said lighted memorial lamp with a memorial lamp structure at said memorial service;
c) exchanging said first, lighted memorial lamp with a second memorial lamp so that said second memorial lamp is associated with said memorial lamp structure; and
d) keeping said second memorial lamp and said associated memorial lamp structure at a memorial place.

2. The method of claim 1 wherein said first memorial lamp is a flame powered lamp.

3. The method of claim 2 wherein said flame powered lamp comprises a candle.

4. The method of claim 1 wherein said second memorial lamp is an electric powered lamp.

5. The method of claim 4 wherein said electric powered lamp is a solar powered lamp.

6. The method of claim 4 wherein said electric powered lamp is a battery powered lamp.

7. A memorial light system, comprising:
a) a housing for holding a first memorial light;
b) a first memorial light; and
c) a second memorial light differing from said first memorial light.

8. A memorial light system according to claim 7, and further including a mount for mounting said memorial light system to a mausoleum.
